(19) United States
(12) Patent Application Publication
(10) Pub. No.: US 2010/0103300 A1
(43) Pub. Date: Apr. 29, 2010

(54) SYSTEMS AND METHODS FOR HIGH RESOLUTION IMAGING

(75) Inventors: Peter W. J. Jones, Belmont, MA (US); Ellen Cargill, Norfolk, MA (US); Dennis W. Purcell, Medford, MA (US)

Correspondence Address: ROPES & GRAY LLP, PATENT DOCKETING 39/41, ONE INTERNATIONAL PLACE, BOSTON, MA, 02110-2624, US

(73) Assignee: Tenebraex Corporation, Boston, MA (US)

(21) Appl. No.: 12/605,801

(22) Filed: Oct. 26, 2009

Related U.S. Application Data
(60) Provisional application No. 61/197,204, filed on Oct. 24, 2008.

(51) Int. Cl. H04N 5/335

(52) U.S. Cl. 348/302; 348/294; 348/E05.091

(57) ABSTRACT

The systems and methods described herein relate to high resolution imaging. In particular, the systems include two or more lens assemblies for imaging a particular scene. Each lens assembly has image sensors disposed behind the lens assembly to image only a portion of the scene viewable through the lens assembly. Image sensors behind different lens assemblies image different portions of the scene. When the imaged portions from all the sensors are combined, a high resolution image of the scene is formed. Thus, multiple sensors can be combined to generate a high resolution image without prospective mismatching, and without the shortcomings associated with the border regions and packaging of the individual sensors, such as image gaps.

### CROSS-REFERENCE TO RELATED APPLICATIONS

This application claims the benefit of U.S. Provisional Patent Application No. 61/197,204, entitled “Systems And Methods For High Resolution Imaging” filed on Oct. 24, 2008, the entire disclosure of which is hereby incorporated by reference as if set forth herein in its entirety.

### BACKGROUND

High-resolution digital cameras are able to resolve small features within a scene from a large distance. Such cameras are useful for creating detailed panoramic, or wide-angle, images of a scene. The resolution of a digital image is limited by the number of pixels (photo-sensing elements) in the camera's imaging sensor. As the number of pixels in an imaging sensor increases, the cost and size of the imaging sensor also increases, typically exponentially with the number of pixels. State-of-the-art 50 mega-pixel (MP) imaging sensors are about 20-25 mm by 14-36 mm in size and typically cost upwards of $20,000. On the other hand, a 1.3 MP imaging sensor may cost as little as $2, and five 10 MP imaging sensors may cost as little as $50.

One method of making high resolution images using a camera with a smaller number of pixels is to take a number of images at locations that cover the desired field of view using a single camera and then combine the images to form a high-resolution composite or mosaic image. However, because of the time elapsed between starting and ending the image capture, moving objects in the scene lead to undesirable effects. For example, if a person is walking down the street during the time a mosaic of the street is captured, that person may appear multiple times in the mosaic. Moving objects might also be split both horizontally and vertically depending on their speed and position.

Another high-resolution imaging method employs an optical system that includes a number of cameras positioned to cover a desired field of view. The cameras may be synchronized to capture the image at the same time, and the images may then be combined. However, each camera has an optical axis that is displaced from their neighboring camera. As a result, each lens has a different perspective of the subject. In order to create a seamless composite image, the perspectives of the captured images must be corrected so that they match. Existing methods to correct perspective involve enlarging or reducing portions of an image using interpolation, which results in a loss of sharpness. Therefore, there is a need for an improved, low-cost high-resolution digital imaging system.

### SUMMARY

The systems and methods described herein relate to high resolution imaging. In particular, the systems include two or more lens assemblies for imaging a particular scene. Each lens assembly has image sensors disposed behind the lens assembly to image only a portion of the scene viewable through the lens assembly. Image sensors behind different lens assemblies image different portions of the scene. When the imaged portions from all the sensors are combined, a high resolution image of the scene is formed. Thus, multiple sensors can be combined into a high resolution image sensor without suffering the shortcomings associated with requiring each of the sensors to be positioned adjacent to each other, namely, image quality deterioration near the border regions of each sensor because of the constraints imposed by packaging of the individual sensors.

According to one aspect of the invention, a system for imaging a scene is provided. The system may include a first lens assembly with a first field of view and a second lens assembly with a second field of view. The first field of view may be substantially the same as the second field of view. The system may also include a first sensor disposed behind the first lens assembly to image only a portion of the first field of view and a second sensor disposed behind the second lens assembly to image only a portion of the second field of view. The imaged portion of the first field of view may be substantially different from the imaged portion of the second field of view. In certain embodiments, the first lens assembly includes a first optical axis, and the second lens assembly includes a second optical axis, and the first optical axis is substantially parallel to the second optical axis.

In some embodiments, an active imaging area of the first sensor may be smaller than the first field of view. In certain embodiments, the first sensor may be disposed in a first focal area of the first lens assembly.

According to another aspect of the invention, a system for imaging a scene is provided. The system may include a plurality of lens assemblies, each with substantially the same field of view. The system may also include a plurality of image sensors, each disposed behind one of the plurality of lens assemblies to image only a portion of the field of view of the respective lens assembly. Each imaged portion of the field of view may be substantially different from the other imaged portions of the field of view, and every portion of the entire field of view may be included in at least one imaged portion. In certain embodiments, each of the plurality of lens assemblies includes an optical axis and each of the plurality of optical axes are substantially parallel to each other.

In some embodiments, the active imaging area of one of the image sensors disposed behind one of the lens assemblies may be smaller than the field of view of the respective lens assembly. In other embodiments, the active imaging area of one or the image sensors may be substantially the same size as the field of view of the respective lens assembly. In certain embodiments, the plurality of image sensors may include a first sensor, the plurality of lens assemblies may include a first lens assembly, and the first sensor may be disposed in a first focal area of the first lens assembly. Optionally, the plurality of image sensors may also include a second sensor, and the plurality of lens assemblies may include a second lens assembly.

In any of the aspects and embodiments described above, the first focal area may be divided into at least a first focal area portion and a second focal area portion, and the first sensor may be disposed in the first focal area portion. Optionally, the active imaging area of the first sensor may be substantially the same size as the first focal area portion.

In some of the aspects and embodiments described above, the first focal area may be divided into an imaging array of imaging cells disposed in rows and columns, where the first focal area portion may correspond to a first imaging cell and the second focal area portion may correspond to a second imaging cell. In any of the aspects and embodiments described above, the second lens assembly may have a second focal area divided into at least a third focal area portion and a fourth focal area portion. The third focal area portion may have substantially the same field of view as the first focal area portion, and the fourth focal area portion may have substantially the same field of view as the second focal area portion. In these embodiments, the second sensor may be disposed in the fourth focal area portion. In some of the aspects and embodiments described above, one or more other sensors may be disposed behind the first lens assembly, and each sensor behind the first lens assembly may not be contiguous to any other sensor.

According to yet another aspect of the invention, a method of imaging a scene is provided. A first portion of the scene may be imaged with a first sensor array assembly having a first field of view. A second portion of the scene, substantially different from the first portion of the scene, may be imaged with a second sensor array assembly having a second field of view. The second field of view may be substantially the same as the first field of view. A processor may combine at least the first portion and the second portion to generate an image of the scene.

In some embodiments, the first sensor array assembly may image the first portion of the scene through a first lens assembly with the first field of view and the second sensor array assembly may image the second portion of the scene through a second lens assembly with the second field of view. In certain embodiments, the imaged first portion of the scene may include only incontiguous sections of the scene. In some embodiments, the imaged second portion of the scene may include only incontiguous sections of the scene, at least one of which is different from one of the incontiguous sections in the imaged first portion of the scene. Optionally, at least one of the incontiguous sections of the imaged first portion is substantially contiguous to at least one of the incontiguous sections of the imaged second portion. In certain embodiments, at least one of the incontiguous sections of the imaged first portion partially overlaps with at least one of the incontiguous sections of the imaged second portion.

In some embodiments, the first sensor assembly may be disposed adjacent to the second sensor assembly. Optionally, the first and second sensor assemblies may be disposed such that there is a gap between the two sensor assemblies.

In any of the aspects and embodiments described above, the first lens assembly may have a nonplanar focal surface, and the curvature of the first focal area may substantially match the curvature of the nonplanar focal surface. In some of the aspects and embodiments described above, the first sensor may have a sensor plane different from the curvature of the first focal area, and may be disposed such that the sensor plane is perpendicular to the chief ray of the first lens assembly at the first focal area. Optionally, light from the first lens assembly to the first sensor may be refracted before it reaches the first sensor such that the chief ray of the light is perpendicular to a sensor plane of the first sensor.

### BRIEF DESCRIPTION OF THE FIGURES

The foregoing and other objects and advantages of the invention will be appreciated more fully from the following further description thereof, with reference to the accompanying drawings, wherein:

FIG. 1 depicts a camera having a lens system and an image sensor, according to an illustrative embodiment of the invention;

FIGS. 2A-B depict imaging systems with high resolutions, according to illustrative embodiments of the invention;

FIG. 3 depicts an imaging system with a plurality of image sensors, according to an illustrative embodiment of the invention;

FIG. 4 depicts the focal plane of a multi-lens imaging system configured in a two-dimensional array, according to an illustrative embodiment of the invention;

FIG. 5 depicts an imaging system with a curved focal surface, according to an illustrative embodiment of the invention;

FIG. 6 depicts an imaging system with tilted sensors, according to an illustrative embodiment of the invention;

FIG. 7 depicts an imaging system with refractive elements, according to an illustrative embodiment of the invention;

FIG. 8 depicts an imaging system according to an illustrative embodiment of the invention; and

FIG. 9 is a flowchart depicting a process for high resolution imaging, according to an illustrative embodiment of the invention.

### DETAILED DESCRIPTION

The systems and methods described herein relate to high resolution imaging. In particular, the systems include two or more lens assemblies for imaging a particular scene. Each lens assembly has image sensors disposed behind the lens assembly to image only a portion of the scene viewable through the lens assembly. Image sensors behind different lens assemblies image different portions of the scene. When the imaged portions from all the sensors are combined, a high resolution image of the scene is formed. Thus, multiple sensors can be combined into a high resolution image sensor without the shortcomings associated with the border regions and packaging of the individual sensors, such as image gaps.

In certain embodiments, the system includes a plurality of lenses arranged in a one or two dimensional array, each lens having a focal area (i.e. a portion of its focal plane) that may be larger than an individual imaging sensor. A plurality of imaging sensors may be located behind each lens to cover the focal area of each lens to capture the entire field of view. The field of view, or focal area, captured behind a lens may be represented by an array having rows and columns of cell regions. Each cell region in this array may be sized to match the size of the active imaging area of an imaging sensor. In addition to an active imaging area, an imaging sensor may include a black level correction boundary region and/or an imaging sensor package. Thus, the active imaging area of an imaging sensor may be substantially smaller than the overall size or footprint of the imaging sensor itself. Because of the disparity between the active imaging area and the overall size/footprint of an imaging sensor, it may be a challenge to place multiple imaging sensors in adjacent cell regions in the focal area cell array behind a particular lens.

In certain embodiments, the imaging sensors behind each lens may be arranged in a sparse array, in which each sensor may be placed in a cell region that is not adjacent to a cell region containing another sensor, resulting in an array of incontiguous sensors. In these embodiments, the focal area array of a particular lens may contain fewer imaging sensors than there are cells within the array. These focal area arrays of incontiguous sensors may be known as sparse arrays. The sparse arrays behind different lenses may have different configurations. For example, the sparse array behind one lens may have more or less sensors than the sparse array behind another lens. Also, the sparse array behind different lenses may be arranged in different physical configurations. For example, the sparse array behind a first lens may have sensors arranged in certain locations on the focal area of the first lens, and the sparse array behind another lens may have sensors arranged in different positions complementary to the positions of the sensors behind the first lens. One advantage of this approach is that the perspective between “adjacent” imaging sensors may be matched, even if the “adjacent” sensors are actually each positioned behind different lenses and not contiguous.

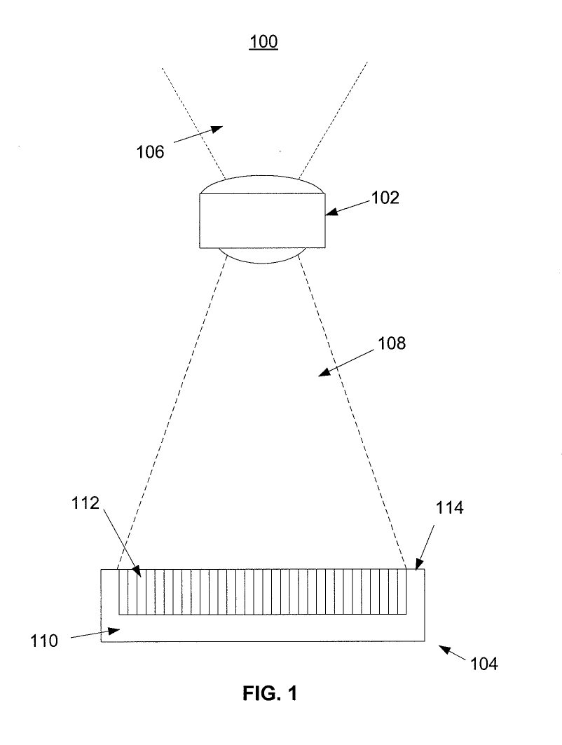

FIG. 1 depicts an imaging system 100 having a lens system 102 and an imaging sensor 104, according to an illustrative embodiment of the invention. The lens system 102 has an angular field of view 106 from which light (from a scene) can be captured by the camera 100. The imaging sensor 104 includes an active imaging area 112 and a boundary region 114. In some embodiments, the boundary region 114 includes the sensor packaging. Light rays from the scene pass through the lens system 102 and are received on the surface of the imaging sensor 104. In certain embodiments, the imaging sensor 104 includes CCD imaging sensors. The imaging sensor 104 may include CMOS imaging sensors. For example, the systems and methods described herein may include image sensors manufactured by Aptina Imaging, San Jose, Calif.; Omnivision, Sunnyvale, Calif.; and Sony Corporation, Tokyo, Japan. The lens system 102 may include one or more lenses, and may be combined with one or more optical, electronic or mechanical elements for directing light from a scene onto the imaging sensor 104. The lenses in the lens system 102 may have one or more configurations, fields of view and specifications, depending on, among other things, the application and the requirements for the design of the system such as angular resolution and field of view. For example, the lens system 102 may include lenses manufactured by Carl Zeiss; Navitar, Rochester, N.Y.; Sunex, Inc., Carlsbad, Calif.; and Edmund Optics, Inc., Barrington, N.J.

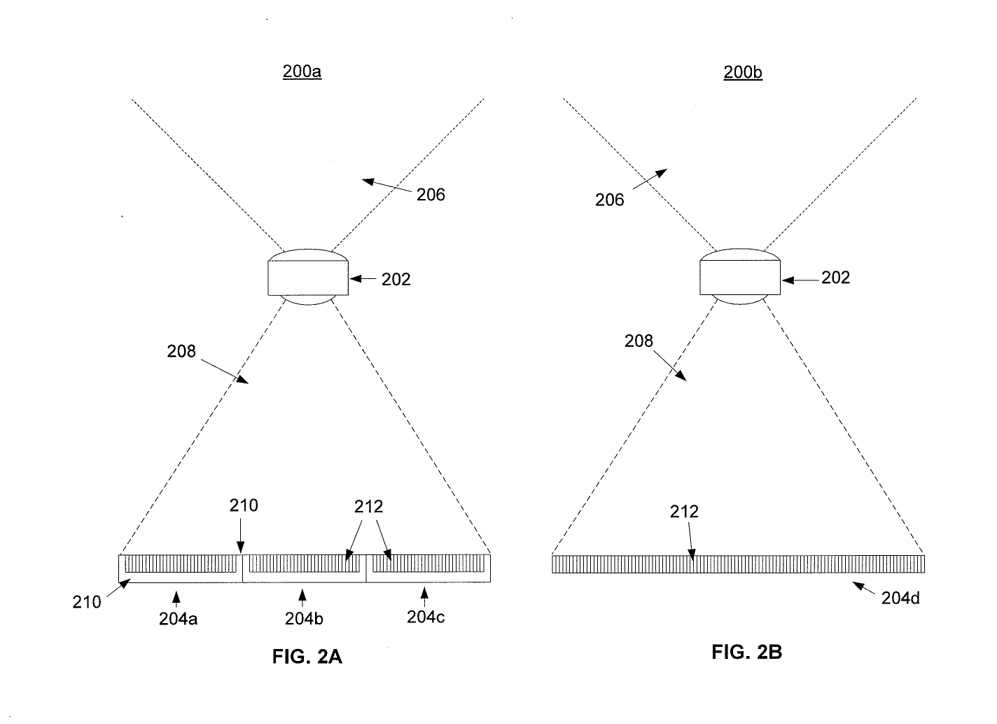

In certain embodiments, a plurality of imaging sensors may be arranged adjacent to each other in a row, or in an array, to increase the resolution of the imaging sensor system. In such a configuration, the plurality of sensors may be smaller than the focal area of the lens and therefore configured to capture a portion of the field of view captured by the lens. FIG. 2A depicts a system 200a having a lens 202 with an angular field of view 206 configured to capture a scene. The system 200 includes an imaging sensor system 203 having a plurality of imaging sensors 204a-c positioned adjacent to each other. The sensor system 203 may be sized and shaped to lie within the focal area of the lens 202 and thereby capture light rays 208 passed through the lens. Each sensor 204a-c in the sensor system 203 includes an active area 212 and a border region 210, similar to those of sensor 104 in FIG. 1. In this configuration, there is a gap about twice the width of the border region between adjacent active imaging areas 212. Consequently, the resolution of a digital image may be adversely affected, because data must be artificially interpolated in the gap region between adjacent active imaging areas 212.

To reduce the gap, a sensor 204d as shown in FIG. 2B may be desired. Sensor 204d includes a plurality of active regions 212 adjacent to each other. However, as noted above, practical considerations such as availability and cost may preclude such a construction. In certain embodiments, it may be desired to arrange several individual, commercially available sensors (e.g., sensor 104) together to form an imaging sensor having a resolution greater than each of the individual sensors but without the shortcomings introduced by the border region and packaging.

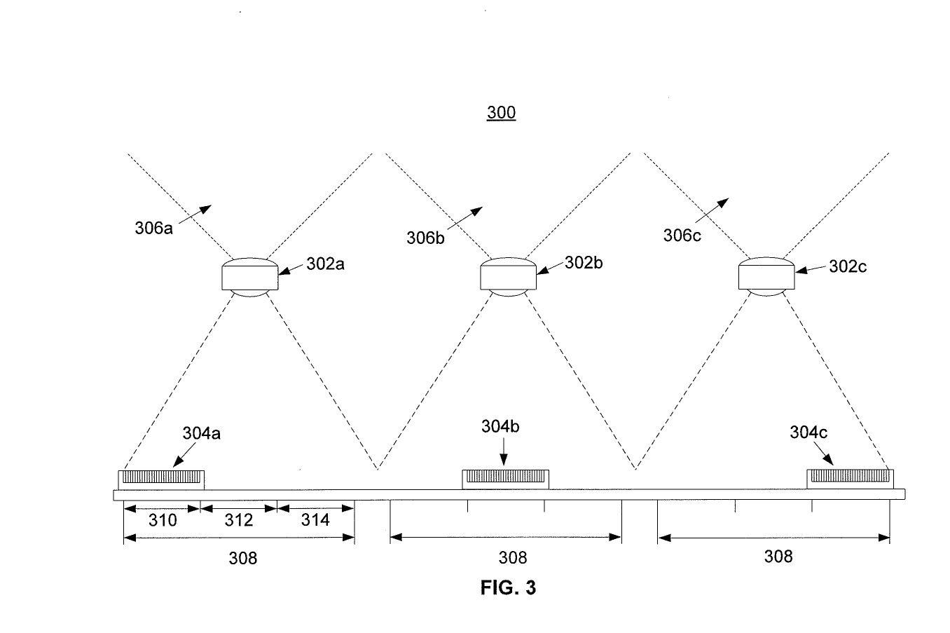

In some embodiments, the system includes a plurality of lenses arranged in a one or two dimensional array, each lens having a focal plane that may be larger than an individual imaging sensor. FIG. 3 depicts a system 300 with three lenses 302a-c, and three imaging sensors 304a-c. Each lens 302a-c may have a corresponding field of view 306a-c. In some embodiments, fields of view 306a-c may be substantially identical. Each respective imaging sensor 304 may be combined with respective lens 302 such that the focal area of the respective lens 302 is larger than the respective imaging sensor 304. The imaging sensors 304a-c may be placed at any suitable location in the focal area of lens 302a-c. In one embodiment, the focal area 308 may be divided into three regions—a left region 310, a middle region 312 and a right region 314. In such embodiments, the imaging sensor 304a may be located in the left region 310 of the focal area of left lens 302a; the imaging sensor 304b may be positioned in the middle region 312 of the focal area of middle lens 302b; and the imaging sensor 304c may be positioned in the left region 314 of the focal plane of right lens 302c. Images captured by each of the three imaging sensors 304a-c may be combined to generate a high-resolution composite image of a scene within the field of view of the system 300. Because the imaging sensors are not placed adjacent or contiguous to each other within the same focal area, system 300 avoids the problem of gaps described with reference to FIG. 2A.

In certain embodiments, a composite image may be created by combining one or more images into a single image having limited, if any, visible seams. In certain embodiments, the first step in combining such images is to align the images spatially using calibration data that describes the overlap regions between adjacent imaging sensors. In such embodiments the exposures and the color balance may be blended. Next, the system may correct for perspective (if required) and optical distortion between adjacent images.

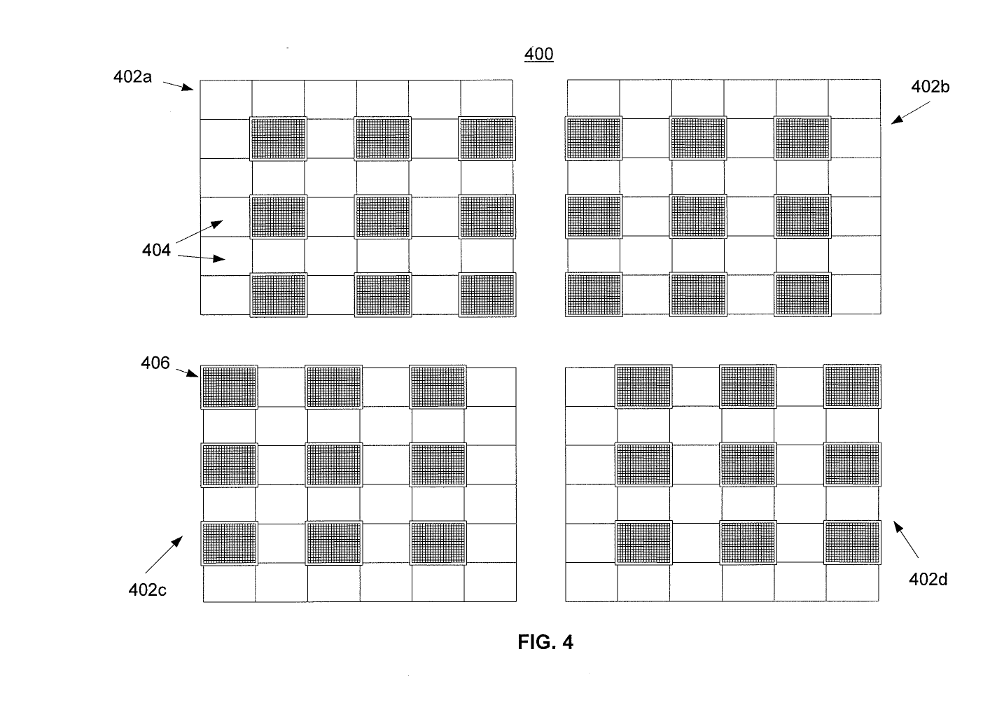

In certain embodiments, the lenses and/or imaging sensors may be arranged in two-dimensional arrays. FIG. 4 illustrates the focal area 400 of a four-lens system configured as a 2×2 array. The lenses focus a scene onto the sub-areas 402a-d. In some embodiments, each of the sub-areas 402a-d may be divided into regions 404. In certain embodiments, each sub-area 402a-d may be divided into a 6×6 array, forming 36 regions 404. A plurality of imaging sensors (e.g., the imaging sensor 104) may be placed at different regions 404 or various positions on the 6×6 array. For example, nine sensors are placed on nine non-adjacent, incontiguous cells in the 6×6 array on each sub-area 402a-d in FIG. 4. In some embodiment, there may be sufficient distance between the incontiguous imaging sensors to allow room for border regions and packaging. The nine sensors in each of the four sub-areas 402a-d may combine to cover the 36 regions on the focal area.

The imaging systems described herein may include any number of lenses and sensors as desired without departing from the scope of the invention. The lenses and sensors may be positioned in arrays of any desired dimension. The focal areas of one or more lenses may be divided into any number of regions depending on, among other things, the desired resolution of the image, the number and/or the specification of the imaging sensors, the number and/or the specification of the lenses, as well as other components and considerations. Lenses may have focal areas of any shape, and imaging sensors mounted so that light exits the lens to impinge on the image sensor surface in a desired manner. Image sensor mounting positions and angles may be chosen to lower color crosstalk and vignetting in the composite image.

In certain embodiments, if the total size of the imaging sensor (i.e., the total size of the imaging sensor 104 including active area 112 and border region 110) is smaller than twice the active area size in both dimensions, then the imaging sensors may be spaced at intervals equal to the dimensions of the active area. Positioning imaging sensors in this manner results in the minimum number of lenses required to cover a desired field of view. An example of such an embodiment is illustrated in FIG. 4, in which the field of view may be covered by sparse arrays behind four lenses because the total sensor size is less than twice the active area size.

In certain embodiments, the ratio of sensors to lenses depends on the active area size, the total sensor size, and the field of view to be covered. The ratio of sensors to lenses may depend on other aspects of the systems and methods described herein, without departing from the scope of the invention. In certain embodiments, if either of the total sensor size dimensions exceeds about twice the corresponding active area dimension, the sensor spacing may need to be increased to the next integral multiple of the corresponding active area size, and more lenses will be required to map to the sparser array of imaging sensors.

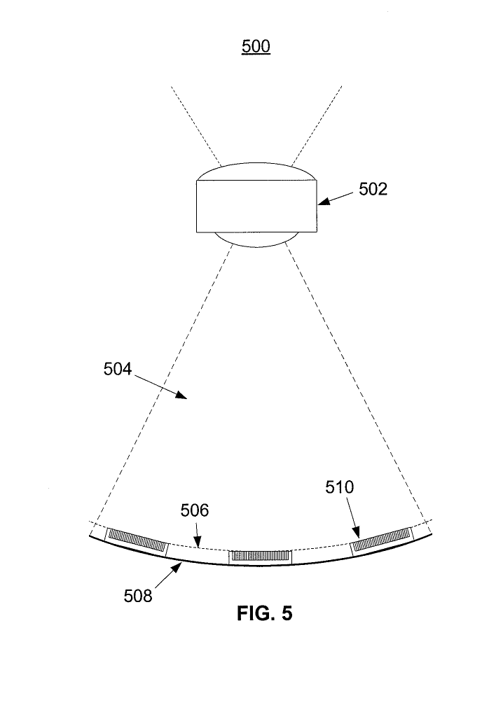

For many lenses, the focal plane may be a spherical surface. In certain embodiments, image sensors may be mounted on a flat substrate or a curved substrate that matches the field curvature of the lens and results in more properly focused images. In particular, FIG. 5 depicts a system 500 having a lens 502 and a plurality of image sensors 510 mounted on a substrate 508 to capture light rays 504. The substrate 508 may be curved to align with a curved focal surface 506. In some embodiments, the image sensors may be mounted in a sparse array, as described above in relation to FIGS. 3-4.

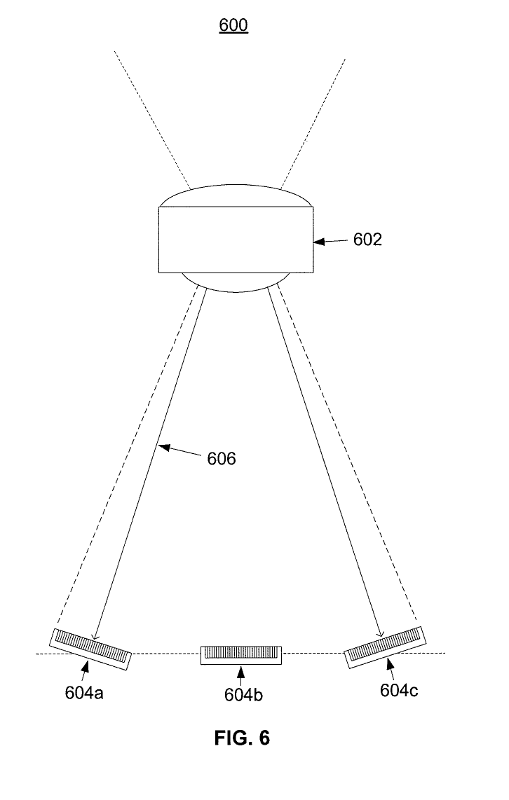

In other embodiments, the image sensors can also be mounted normal to the chief ray of the lens at the image sensor position in the focal area. For example, FIG. 6 depicts a system 600 having a lens 602 and three image sensors 604a-c. The image sensors 604a-c are positioned in the focal area of the lens 602 and are angled such that light rays from the lens, such as light ray 606, strike each sensor normal to its surface. Sensors 604a and 604c may be angled to face the direction of the lens 602. The advantage to this embodiment is that the change in the chief ray over the area of the image sensor is minimized, thereby minimizing color crosstalk and vignetting caused by light impinging on the photodiode area in the sensor at non-normal incidence. In some embodiments, the image sensors may be mounted in a sparse array, as described above in relation to FIGS. 3-4.

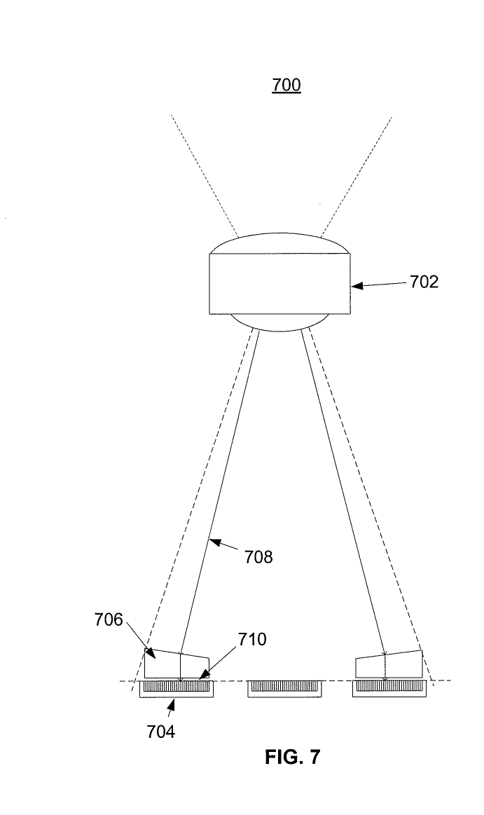

In another embodiment, image sensors can be mounted on a flat substrate and a prism can be mounted on the image sensor to bend the incident rays and make them normal to the image sensor. FIG. 7 depicts a system 700 having a lens 702 and a plurality of sensors 704 positioned in the focal area of the lens. The sensors 704 that are positioned at a location where rays from the lens 702 strike at an angle are coupled with one or more optical elements, such as, but not limited to, prism 706. As shown in FIG. 7, the light ray 708 from the lens 702 strike the angled surface of the prism 706 and then are refracted to be perpendicular to the surface 710 of the sensor 704. The benefit of this approach is that it matches the chief ray of the incident light to the desired chief ray angle for the image sensor. This approach likewise results in reduced color crosstalk and vignetting. In some embodiments, the image sensors may be mounted in a sparse array, as described above in relation to FIGS. 3-4.

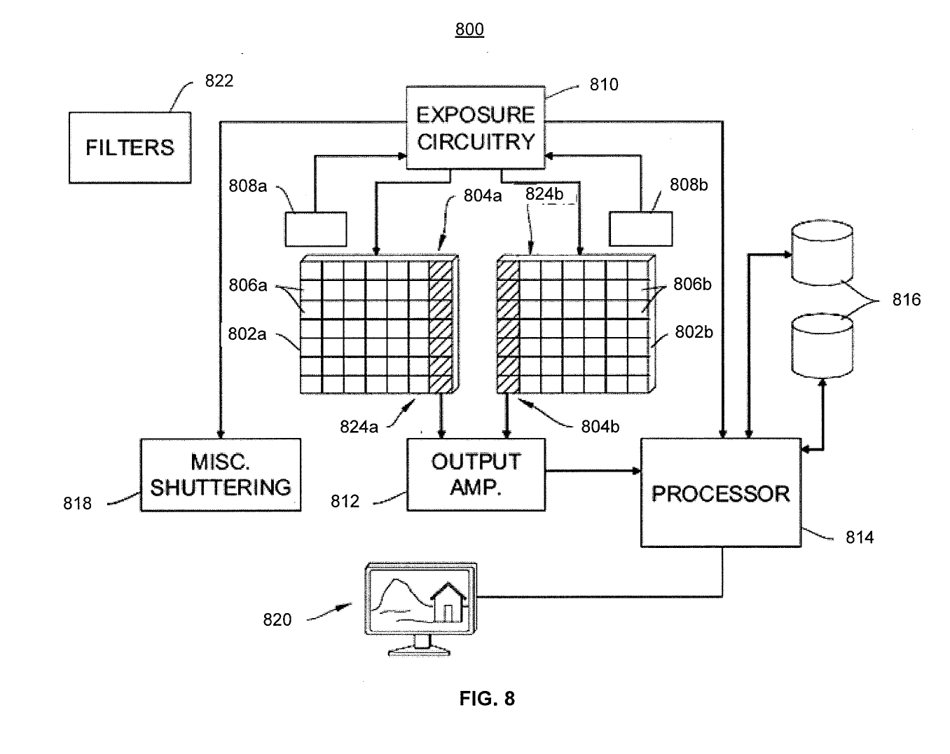

FIG. 8 depicts an imaging system 800 having multiple sensors, according to an illustrative embodiment of the invention. In particular, system 800 includes imaging sensors 802a and 802b. In some embodiments, sensors 802a and 802b may be positioned such that they are not adjacent to each other. In other embodiments, sensors 802a and 802b may be positioned adjacent to each other. Generally, system 800 may include two or more imaging sensors arranged on a one- or two-dimensional array in any configuration without departing from the scope of the invention. For example, system 800 may include 36 sensors arranged in the configuration shown in FIG. 4.

Light meters 808a and 808b are connected to the sensors 802a and 802b for determining incident light on the sensors. The light meters 808a and 808b and the sensors 802a and 802b are connected to exposure circuitry 810. The exposure circuitry 810 is configured to determine an exposure value for each of the sensors 802a and 802b. In certain embodiments, the exposure circuitry 810 determines the best exposure value for a sensor for imaging a given scene. The exposure circuitry 810 is optionally connected to miscellaneous mechanical and electronic shuttering systems 818 for controlling the timing and intensity of incident light and other electromagnetic radiation on the sensors 802a and 802b. The sensors 802a and 802b may optionally be coupled with one or more filters 822. In certain embodiments, filters 822 may preferentially amplify or suppress incoming electromagnetic radiation in a given frequency range.

In some embodiments, imaging system 800 may include mechanisms (not shown) to actuate one or more of sensors 802a and 802b. For example, imaging system 800 may include mechanisms to tilt or slide sensors 802a and/or 802b with respect to each other, the lens focal plane, or any other suitable axis. In certain embodiments, imaging system 800 may include one or more refractors (not shown), such as prism 706 (FIG. 7), for refracting light before it reaches the sensors 802a and/or 802b.

In certain embodiments, sensor 802a includes an array of photosensitive elements (or pixels) 806a distributed in an array of rows and columns. The sensor 802a may include a charge-CCD imaging sensor. In certain embodiments, the sensor 802a includes a CMOS imaging sensor. In certain embodiments, the sensor 802b is similar to the sensor 802a. The sensor 802b may include a CCD and/or CMOS imaging sensor. The sensors 802a and 802b may be positioned adjacent to each other, either vertically or horizontally. The sensors 802a and 802b may be included in an optical head of an imaging system. In certain embodiments, the sensors 802a and 802b may be configured, positioned or oriented to capture different fields-of-view of a scene. The sensors 802a and 802b may be angled depending on the desired extent of the field-of-view. During operation, incident light from a scene being captured may fall on the sensors 802a and 802b. In certain embodiments, the sensors 802a and 802b may be coupled to a shutter and when the shutter opens, the sensors 802a and 802b are exposed to light. The light may then converted to a charge in each of the photosensitive elements 806a and 806b.

The sensors can be of any suitable type and may include CCD imaging sensors, CMOS imaging sensors, or any analog or digital imaging sensor. The sensors may be color sensors. The sensors may be responsive to electromagnetic radiation outside the visible spectrum, and may include thermal, gamma, multi-spectral and x-ray sensors. The sensors, in combination with other components in the imaging system 700, may generate a file in any format, such as the raw data, GIF, JPEG, TIFF, PBM, PGM, PPM, EPSF, X11 bitmap, Utah Raster Toolkit RLE, PDS/VICAR, Sun Rasterfile, BMP, PCX, PNG, IRIS RGB, XPM, Targa, XWD, PostScript, and PM formats on workstations and terminals running the X11 Window System or any image file suitable for import into the data processing system. Additionally, the system may be employed for generating video images, including digital video images in the .AVI, .WMV, .MOV, .RAM and .MPG formats.

In certain embodiments, once the shutter closes, light is blocked and the charge may then be transferred from an imaging sensor and converted into an electrical signal. In such embodiments, charge from each column is transferred along the column to an output amplifier 812, a technique typically referred to as a rolling shutter. The term “rolling shutter” may also be used to refer to other processes which generally occur column-wise or row-wise at each sensor, including charge transfer and exposure adjustment. Charge may first be transferred from each pixel in the columns 804a and 804b. In certain embodiments, after this is completed, charges from the columns 824a and 824b (adjacent to the columns 804a and 804b, respectively) are first transferred to the columns 804a and 804b, respectively, and then transferred along the columns 804a and 804b to the output amplifier 812. Similarly, charges from each of the remaining columns are moved over by one column towards the columns 804a and 804b and then transferred to output amplifier 812. The process may repeat until all or substantially all charges are transferred to the output amplifier 812.

In a further embodiment, the rolling shutter's column-wise transfer of charge is achieved by orienting a traditional imaging sensor vertically. Generally, traditional imaging sensors are designed for row-wise transfer of charge, instead of a column-wise transfer as described above. However, these traditional imaging sensors may be oriented on their sides such that rows now function as columns and allow for column-wise transfer. The output amplifier 812 may be configured to transfer charges and/or signals to a processor 814.

The processor 814 may include microcontrollers and microprocessors programmed to receive data from the output amplifier 812 and exposure values from the exposure circuitry 810, and determine interpolated exposure values for each column in each of the sensors 802a and 802b. In particular, processor 814 may include a central processing unit (CPU), a memory, and an interconnect bus (not shown). The CPU may include a single microprocessor or a plurality of microprocessors for configuring the processor 814 as a multi-processor system. The memory may include a main memory and a read-only memory. The processor 814 and/or the databases 816 also include mass storage devices having, for example, various disk drives, tape drives, FLASH drives, etc. The main memory also includes dynamic random access memory (DRAM) and high-speed cache memory. In operation, the main memory stores at least portions of instructions and data for execution by a CPU.

The mass storage 816 may include one or more magnetic disk or tape drives or optical disk drives, for storing data and instructions for use by the processor 814. At least one component of the mass storage system 816, possibly in the form of a disk drive or tape drive, stores the database used for processing the signals measured from the sensors 802a and 802b. The mass storage system 816 may also include one or more drives for various portable media, such as a floppy disk, a compact disc read-only memory (CD-ROM), DVD, or an integrated circuit non-volatile memory adapter (i.e. PC-MCIA adapter) to input and output data and code to and from the processor 814.

The processor 814 may also include one or more input/output interfaces for data communications. The data interface may be a modem, a network card, serial port, bus adapter, or any other suitable data communications mechanism for communicating with one or more local or remote systems. The data interface may provide a relatively high-speed link to a network, such as the Internet. The communication link to the network may be, for example, optical, wired, or wireless (e.g., via satellite or cellular network). Alternatively, the processor 814 may include a mainframe or other type of host computer system capable of communications via the network.

The processor 814 may also include suitable input/output ports or use the interconnect bus for interconnection with other components, a local display 820, and keyboard or other local user interface for programming and/or data retrieval purposes (not shown).

In certain embodiments, the processor 814 includes circuitry for an analog-to-digital converter and/or a digital-to-analog converter. In such embodiments, the analog-to-digital converter circuitry converts analog signals received at the sensors to digital signals for further processing by the processor 814.

The components of the processor 814 are those typically found in imaging systems used for portable use as well as fixed use. In certain embodiments, the processor 814 includes general purpose computer systems used as servers, workstations, personal computers, network terminals, and the like. Certain aspects of the systems and methods described herein may relate to the software elements, such as the executable code and database for the server functions of the imaging system 800.

Generally, the methods described herein may be executed on a conventional data processing platform such as an IBM PC-compatible computer running the Windows operating systems, a SUN workstation running a UNIX operating system or another equivalent personal computer or workstation. Alternatively, the data processing system may comprise a dedicated processing system that includes an embedded programmable data processing unit.

Certain embodiments of the systems and processes described herein may also be realized as software component operating on a conventional data processing system such as a UNIX workstation. In such embodiments, the processes may be implemented as a computer program written in any of several languages well-known to those of ordinary skill in the art, such as (but not limited to) C, C++, FORTRAN, Java or BASIC. The processes may also be executed on commonly available clusters of processors, such as Western Scientific Linux clusters, which may allow parallel execution of all or some of the steps in the process.

Certain embodiments of the methods described herein may be performed in either hardware, software, or any combination thereof, as those terms are currently known in the art. In particular, these methods may be carried out by software, firmware, or microcode operating on a computer or computers of any type, including pre-existing or already-installed image processing facilities capable of supporting any or all of the processor's functions. Additionally, software embodying these methods may comprise computer instructions in any form (e.g., source code, object code, interpreted code, etc.) stored in any computer-readable medium (e.g., ROM, RAM, magnetic media, punched tape or card, compact disc (CD) in any form, DVD, etc.). Furthermore, such software may also be in the form of a computer data signal embodied in a carrier wave, such as that found within the well-known Web pages transferred among devices connected to the Internet. Accordingly, these methods and systems are not limited to any particular platform, unless specifically stated otherwise in the present disclosure.

The systems described herein may include additional electronic, electrical and optical hardware and software elements for capturing images without departing from the scope of the invention. For example, the system may include single-shot systems, which in turn, may include one or more color filters coupled with the imaging sensors (e.g., CCD or CMOS). In certain embodiments, the imaging sensor is exposed to the light from a scene a desired number of times. The system may be configured to capture images using one or more imaging sensors with a Bayer filter mosaic, or three or more imaging sensors (for one or more spectral bands) which are exposed to the same image via a beam splitter. In another embodiment, the system includes multi-shot systems in which the sensor may be exposed to light from a scene in a sequence of three or more openings of the lens aperture. In such embodiments, one or more imaging sensors may be combined with three filters (e.g., red, green and blue) passed in front of the sensor in sequence to obtain the additive color information. In other embodiments, the systems described herein may be combined with computer systems for operating the lenses and/or sensors and processing captured images.

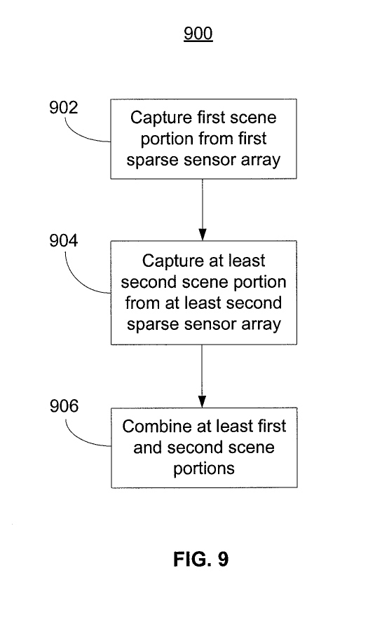

FIG. 9 is a flowchart depicting a process 900 for high resolution imaging, according to an illustrative embodiment of the invention. In step 902, a first image or a first portion of a scene is captured by a first sensor array. In some embodiments, the first sensor array may be a sparse sensor array that includes one or more sensors disposed in one or more cells of a first imaging array. In some embodiments, the number of cells in the first imaging array may exceed the number of sensors disposed in the first array. If the first sensor array includes more than one sensor, the sensors may be disposed in nonadjacent cells of the first imaging array. In these embodiments, the captured first portion of the scene may include two or more nonadjacent or incontiguous sections of the scene.

In step 904, a second image or a second portion of the scene is captured by a second sensor array. The second sensor array may also be a sparse sensor array that includes one or more sensors disposed in one or more cells of a second imaging array. In some embodiments, the number of cells in the second imaging array may exceed the number of sensors disposed in the second array. If the second sensor array includes more than one sensor, the sensors may be disposed in nonadjacent cells of the second imaging array. In these embodiments, the captured second portion of the scene may include two or more nonadjacent or incontiguous sections of the scene. In certain embodiments, the one or more sensors in the second imaging array may be disposed in cells that are adjacent to cells that correspond to cells in the first imaging array that contain sensors. Thus, while the captured second portion of the scene may include only incontiguous sections of the scene, these portions may be contiguous to sections of the scene in the captured first portion of the scene.

In step 906, the captured first and second portions of the scene may be combined to form an high resolution image of the scene by, for example, processor 814 (FIG. 8). In some embodiments, more than two portions of the scene may be combined to form the high resolution image of the scene. The combination of the at least two portions of the scene may be accomplished by stitching adjacent, contiguous sections or portions together, or by data interpolation.

Those skilled in the art will know or be able to ascertain using no more than routine experimentation, many equivalents to the embodiments and practices described herein. Variations, modifications, and other implementations of what is described may be employed without departing from the spirit and scope of the invention. More specifically, any of the method, system and device features described above or incorporated by reference may be combined with any other suitable method, system or device features disclosed herein or incorporated by reference, and is within the scope of the contemplated inventions. The systems and methods may be embodied in other specific forms without departing from the spirit or essential characteristics thereof. The foregoing embodiments are therefore to be considered in all respects illustrative, rather than limiting of the invention. The teachings of all references cited herein are hereby incorporated by reference in their entirety.

1. A system for imaging a scene, comprising:
a first lens assembly with a first field of view,
a second lens assembly with a second field of view substantially the same as the first field of view,
a first sensor disposed behind the first lens assembly to image only a portion of the first field of view, and
a second sensor disposed behind the second lens assembly to image only a portion of the second field of view; wherein
the imaged portion of the first field of view is substantially different from the imaged portion of the second field of view.

2. The system of claim 1, wherein an active imaging area of the first sensor is smaller than the first field of view.

3. The system of claim 1, wherein the first sensor is disposed in a first focal area of the first lens assembly.

4. The system of claim 3, wherein
the first focal area is divided into at least a first focal area portion and a second focal area portion; and
the first sensor is disposed in the first focal area portion.

5. The system of 4, wherein an active imaging area of the first sensor is substantially the same size as the first focal area portion.

6. The system of 4, wherein
the first focal area is divided into an imaging array of imaging cells disposed in rows and columns, and
the first focal area portion corresponds to a first imaging cell and the second focal area portion corresponds to a second imaging cell different from the first imaging cell.

7. The system of claim 4, wherein
the second lens assembly has a second focal area divided into at least a third focal area portion and a fourth focal area portion;
the third focal area portion has substantially the same field of view as the first focal area portion;
the fourth focal area portion has substantially the same field of view as the second focal area portion; and
the second sensor is disposed in the fourth focal area portion.

8. The system of claim 4, further comprising one or more other sensors disposed behind the first lens assembly, and wherein each sensor behind the first lens assembly is not contiguous to any other sensor.

9. The system of claim 3, wherein
the first lens assembly has a nonplanar focal surface; and
the curvature of the first focal area substantially matches the curvature of the nonplanar focal surface.

10. The system of claim 3, wherein
the first sensor has a sensor plane different from the curvature of the first focal area; and
the first sensor is disposed such that the sensor plane is perpendicular to the chief ray of the first lens assembly at the first focal area.

11. The system of claim 3, wherein light from the first lens assembly to the first sensor is refracted before it reaches the first sensor such that the chief ray of the light is perpendicular to a sensor plane of the first sensor.

12. The system of claim 1, wherein the first lens assembly includes a first optical axis, and the second lens assembly includes a second optical axis, and wherein the first optical axis is substantially parallel to the second optical axis.

13. A system for imaging a scene, comprising:
a plurality of lens assemblies, each with substantially the same field of view,
a plurality of image sensors, each disposed behind one of the plurality of lens assemblies to image only a portion of the field of view of the respective lens assembly; wherein
each imaged portion of the field of view is substantially different from the other imaged portions of the field of view, and
every portion of the entire field of view is included in at least one imaged portion.

14. The system of claim 13, wherein an active imaging area of one of the image sensors disposed behind one of the lens assemblies is smaller than the field of view of the respective lens assembly.

15. The system of claim 13, wherein
the plurality of image sensors includes a first sensor;
the plurality of lens assemblies includes a first lens assembly; and
the first sensor is disposed in a first focal area of the first lens assembly.

16. The system of claim 15, wherein
the first focal area is divided into at least a first focal area portion and a second focal area portion; and
the first sensor is disposed in the first focal area portion.

17. The system of 16, wherein an active imaging area of the first sensor is substantially the same size as the first focal area portion.

18. The system of 16, wherein
the first focal area is divided into an imaging array of imaging cells disposed in rows and columns;
the first focal area portion corresponds to a first imaging cell; and
the second focal area portion corresponds to a second imaging cell different from the first imaging cell.

19. The system of claim 16, wherein
the plurality of image sensors includes a second sensor;
the plurality of lens assemblies includes a second lens assembly;
the second lens assembly has a second focal area divided into at least a third focal area portion and a fourth focal area portion;
the third focal area portion has substantially the same field of view as the first focal area portion;
the fourth focal area portion has substantially the same field of view second focal area portion; and
the second sensor is disposed in the fourth focal area portion.

20. The system of claim 16, wherein
the plurality of image sensors includes one or more other sensors disposed behind the first lens assembly and
each of the sensors disposed behind the first lens assembly is not contiguous to any other sensor.

21. The system of claim 15, wherein
the first lens assembly has a nonplanar focal surface; and
the curvature of the first focal area substantially matches the curvature of the nonplanar focal surface.

22. The system of claim 15, wherein
the first sensor has a sensor plane different from the curvature of the first focal area; and
the first sensor is disposed such that the sensor plane is perpendicular to the chief ray of the first lens assembly at the first focal area.

23. The system of claim 15, wherein light from the first lens assembly to the first sensor is refracted before it reaches the first sensor such that the chief ray of the light is perpendicular to a sensor plane of the first sensor.

24. The system of claim 13, wherein each of the plurality of lens assemblies includes an optical axis and each of the plurality of optical axes are substantially parallel to each other.

25. A method of imaging a scene, comprising:
imaging, with a first sensor array assembly having a first field of view, a first portion of the scene;
imaging, with a second sensor array assembly having a second field of view substantially the same as the first field of view, a second portion of the scene substantially different from the first portion of the scene; and
combining, with a processor, at least the first portion and the second portion to generate an image of the scene.

26. The method of claim 25, wherein the first sensor array assembly images the first portion of the scene through a first lens assembly with the first field of view and the second sensor array assembly images the second portion of the scene through a second lens assembly with the second field of view.

27. The method of claim 25, wherein the imaged first portion of the scene includes only incontiguous sections of the scene.

28. The method of claim 27, wherein the imaged second portion of the scene includes only incontiguous sections of the scene, at least one of which is different from one of the incontiguous sections in the imaged first portion of the scene.

29. The method of 28, wherein at least one of the incontiguous sections of the imaged first portion is substantially contiguous to at least one of the incontiguous sections of the imaged second portion.

30. The method of 29, wherein at least one of the incontiguous sections of the imaged first portion partially overlaps with at least one of the incontiguous sections of the imaged second portion.

31. The method of claim 25, wherein the first sensor assembly is disposed adjacent to the second sensor assembly.

32. The method of claim 25, wherein the first and second sensor assemblies are disposed such that there is a gap between the first sensor assembly and the second sensor assembly.

33. The method of claim 26, wherein
the first lens assembly has a first, nonplanar focal surface; and
the first sensor array assembly is disposed such that the curvature of a first sensor array surface of the first sensor array assembly matches the first focal surface.

34. The method of claim 26, wherein a first sensor in the first sensor array surface is disposed such that a first sensor plane associated with the first sensor is different from the first sensor array surface and is perpendicular to the chief ray of the first lens assembly at the first sensor.

35. The method of claim 26, wherein light from the first lens assembly to a first sensor in the first sensor array assembly having a first sensor plane is refracted before it reaches the first sensor such that the chief ray of the light is perpendicular to the first sensor plane.
